(19) United States
(12) Patent Application Publication
(10) Pub. No.: US 2009/0267864 A1
(43) Pub. Date: Oct. 29, 2009

(54) PATCHED INVERSE F ANTENNA

(75) Inventor: Meng-Chien Chiang, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: SERCOMM CORPORATION, Taipei (TW)

(21) Appl. No.: 12/366,714

(22) Filed: Feb. 6, 2009

(30) Foreign Application Priority Data
Apr. 24, 2008 (CN) 200820112012.3

(51) Int. Cl. H01Q 1/36

(52) U.S. Cl. 343/899

(57) ABSTRACT

A patched inverse F antenna (PIFA) antenna is provided. The PIFA antenna includes a ground portion, a radiation portion, a short-circuit portion and a feed-in portion. The width of the radiation portion is larger than the width of the ground portion, such that the operating band of the PIFA antenna covers at least a first band and a second band at the same time. The short-circuit portion is disposed on the ground portion and is connected to the radiation portion. The feed-in portion is connected to the radiation portion.

This application claims the benefit of People's Republic of China application Serial No. 200820112012.3, filed Apr. 24, 2008, the subject matter of which is incorporated herein by reference.

### BACKGROUND OF THE INVENTION

1. Field of the Invention

The invention relates in general to a patched inverse F antenna (PIFA), and more particularly to a PIFA antenna capable of supporting multiple bands at the same time.

2. Description of the Related Art

Z-wave is a new generation transmission technology for wireless network. The Z-wave transmission technology allows every appliance in a household to stand along and communicate with other devices in the same network via wireless signal, hence dispensing the use of a central controller. Many home appliances can be automatically controlled according to the transmission technology. For example, when a user sends a setting to a home appliance from outdoors, a wireless signal is sent to the sensor of the appliance and the appliance will execute the instruction and function accordingly.

Compared with other wireless network such as WiFi and Bluetooth, the Z-wave transmission technology has lower power consumption because the Z-wave transmission technology only transmits a small volume of data around the house and the transmitter thereof is always in a near standby state, hence increasing the duration of battery and providing more convenience.

The main bands of the current Z-wave protocol include the CE band and the FCC band. The CE band is 868.42 MHz, and the FCC band is 908.42 MHz. To operate under a band of 868.42 MHz, an antenna conforming to the CE protocol is used; to operate under a band of 908.42 MHz, an antenna conforming to the FCC protocol is used.

However, the current antenna used in the Z-wave still cannot support both the CE and FCC bands at the same time. Thus, how to provide an antenna used in Z-wave and capable of supporting both the CE and FCC bands at the same time has become an imminent issue to be resolved in the field of wireless communication.

### SUMMARY OF THE INVENTION

The invention is directed to a patched inverse F antenna (PIFA). The width of the radiation portion is designed to be larger than the width of the ground portion, such that the operating band of the PIFA antenna covers multiple bands at the same time.

According to a first aspect of the present invention, a patched inverse F antenna (PIFA) antenna is provided. The PIFA antenna includes a ground portion, a radiation portion, a short-circuit portion and a feed-in portion. The width of the radiation portion is larger than the width of the ground portion, such that the operating band of the PIFA antenna covers at least a first band and a second band at the same time. The short-circuit portion is disposed on the ground portion and is connected to the radiation portion. The feed-in portion is connected to the radiation portion.

The invention will become apparent from the following detailed description of the preferred but non-limiting embodiments. The following description is made with reference to the accompanying drawings.

### BRIEF DESCRIPTION OF THE DRAWINGS

FIG. 1 shows a 3-D perspective of a PIFA antenna according to a preferred embodiment of the invention;

FIG. 2 shows a 3-D perspective of a PIFA antenna according to a preferred embodiment of the invention;

FIG. 3 shows a return loss curve of the PIFA antenna 10;

FIG. 4A shows an X-Z plane radiation field pattern of the PIFA antenna 10 under 868 MHz;

FIG. 4B shows a Y-Z plane radiation field pattern of the PIFA antenna 10 under 868 MHz;

FIG. 4C shows an X-Y plane radiation field pattern of the PIFA antenna 10 under 868 MHz;

FIG. 5A shows an X-Z plane radiation field pattern of the PIFA antenna 10 under 888 MHz;

FIG. 5B shows a Y-Z plane radiation field pattern of the PIFA antenna 10 under 888 MHz;

FIG. 5C shows an X-Y plane radiation field pattern of the PIFA antenna 10 under 888 MHz;

FIG. 6A shows an X-Z plane radiation field pattern of the PIFA antenna 10 under 908 MHz;

FIG. 6B shows a Y-Z plane radiation field pattern of the PIFA antenna 10 under 908 MHz; and

FIG. 6C shows an X-Y plane radiation field pattern of the PIFA antenna 10 under 908 MHz.

### DETAILED DESCRIPTION OF THE INVENTION

The conventional Z-wave antenna cannot support the CE and the FCC band at the same time. To resolve the above problem, the invention provides a patched inverse F antenna (PIFA) capable of covering multiple bands at the same time covers. The PIFA antenna includes a ground portion, a radiation portion, a short-circuit portion and a feed-in portion. The width of the radiation portion is larger than the width of the ground portion, such that the operating band of the PIFA antenna covers multiple bands at the same time. The short-circuit portion is disposed on the ground portion and is connected to the radiation portion. The feed-in portion is connected to the radiation portion to transmit a signal. To further elaborate the spirit and application of the invention, a preferred embodiment is disclosed below.

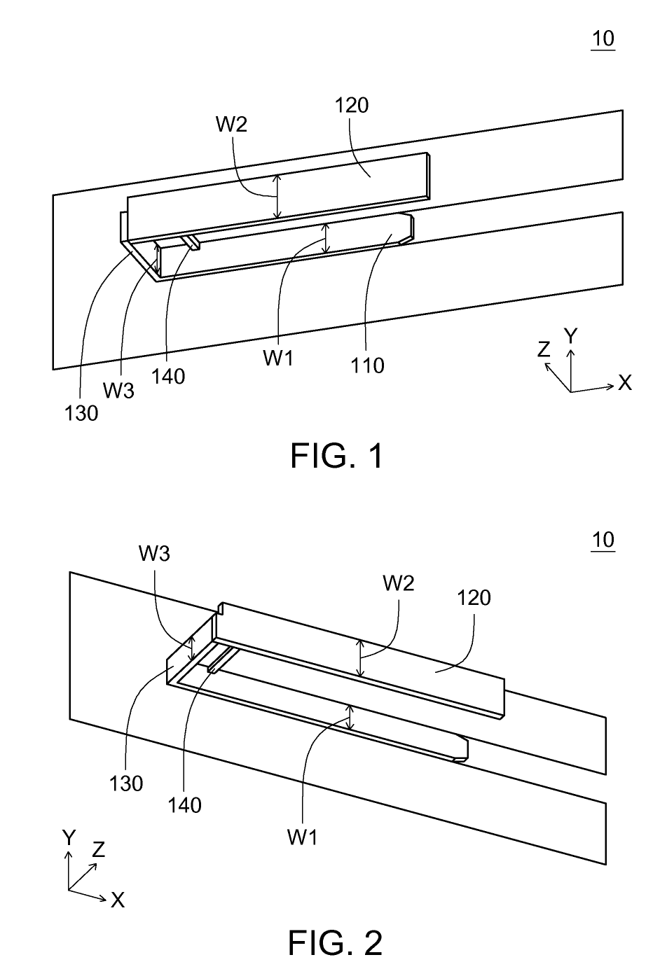

Referring to both FIG. 1 and 2, two 3-D perspectives of a PIFA antenna according to a preferred embodiment of the invention are shown. The PIFA antenna 10 is used in Z-wave communication and conforms to Z-wave protocol. The PIFA antenna 10 includes a ground portion 110, a radiation portion 120, a short-circuit portion 130, and a feed-in portion 140. The widths of the ground portion 110, the radiation portion 120, and the short-circuit portion 130 are respectively designated as the width W1 the width W2 and the width W3. The radiation portion 120 and the short-circuit portion 130 are rectangular metallic pieces and the ground portion 110 is beveled metallic piece for example.

The radiation portion 120 is used for receiving/transmitting a wireless signal, wherein one end of the radiation portion 120 is connected to one end of the short-circuit portion 130. The short-circuit portion 130 is vertically disposed on the ground portion 110, and the other end of the short-circuit portion 130 is connected to one end of the ground portion 110. The radiation portion 120 is electrically connected to the ground portion 110 via the short-circuit portion 130, and the plane of the radiation portion 120 is substantially parallel to the plane of the ground portion 110, wherein the other end of the ground portion 110 is beveled structure for broadening bandwidth and enhance radiation efficiency.

The widths of the ground portion 110, the radiation portion 120 and the short-circuit portion 130 are designed as the width W2>the width W1=the width W3 for example. In a conventional PIFA antenna, the width of the radiation portion is smaller than the width of the ground portion. To resolve the problem that the conventional Z-wave antenna cannot support the CE band and the FCC band at the same time, the width W2 of the radiation portion 120 is preferably designed to be larger than the width W1 of the ground portion 110 in the preferred embodiment of the invention. As the width W2 of the radiation portion 120 is larger than the width W1 of the ground portion 110, the operating band of the PIFA antenna 10 covers the operating band for the CE and the FCC protocol at the same time. That is, the PIFA antenna 10 preferably covers 868.42 MHz band and 908.42 MHz band at the same time, and the ratio of the width W2 vs. the width W1 preferably ranges from 1.15 to 2.

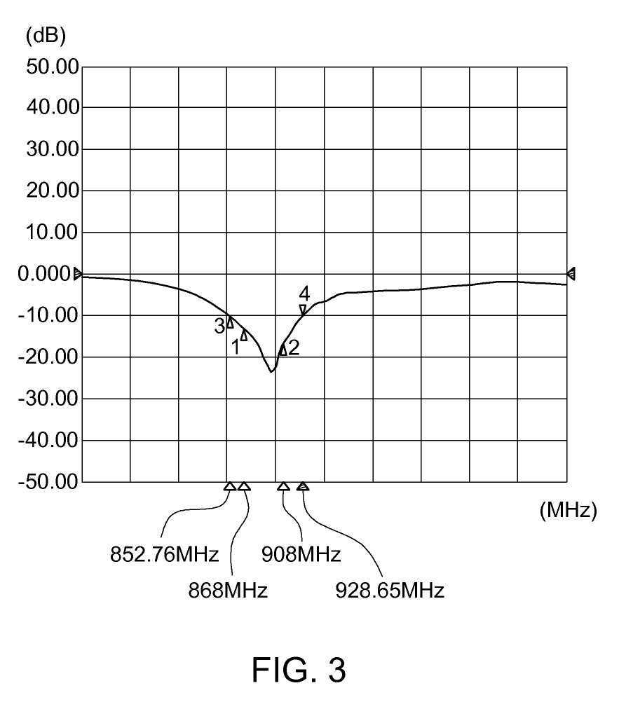

Referring to FIG. 3, a return loss curve of the PIFA antenna 10 is shown. In FIG. 3, the return losses of the PIFA antenna 10 under frequency 868 MHz, 908 MHz, 852.76 MHz and 928.65 Mz are respectively designated as 1, 2, 3 and 4, and the return losses of the PIFA antenna 10 under frequency 868 MHz, 908 MHz, 852.76 MHz and 928.65 Mz respectively correspond to −13.366 dB, −16.929 dB, −10.197 dB and −10.201 dB.

As indicated in FIG. 3, when the return loss of the PIFA antenna 10 substantially is equal to −10 dB, the operating band of the PIFA antenna 10 covers 852.76 MHz and 928.65 Mz band at the same time. That is, when the above width W2 is larger than the width W1, the operating band of the PIFA antenna 10 covers the CE band of 868.42 MHz, and the FCC band of 908.42 MHz at the same time.

To further elaborate the PIFA antenna 10 in greater details, the radiation field patterns of the PIFA antenna 10 operating in different bands are disclosed below. Normally, when the antenna is measured when standing along, if the efficiency is over 70% and the gain is larger than 1 dB, then the antenna will function normally when disposed in the housing of an electronic device. The standing along condition refers to the condition when there are no electronic elements surrounding and causing interference to the antenna and the antenna is not disposed in the housing.

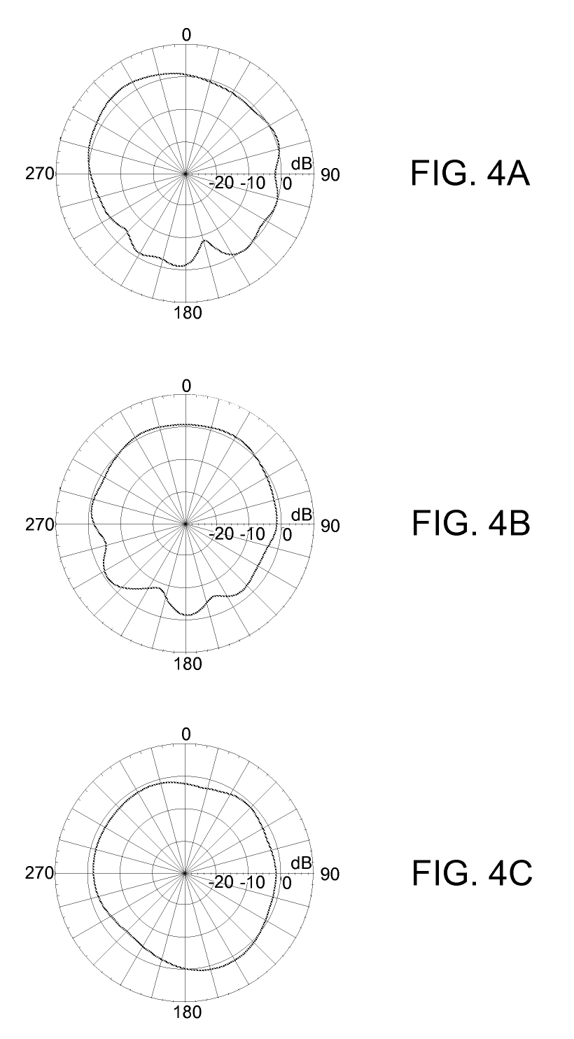

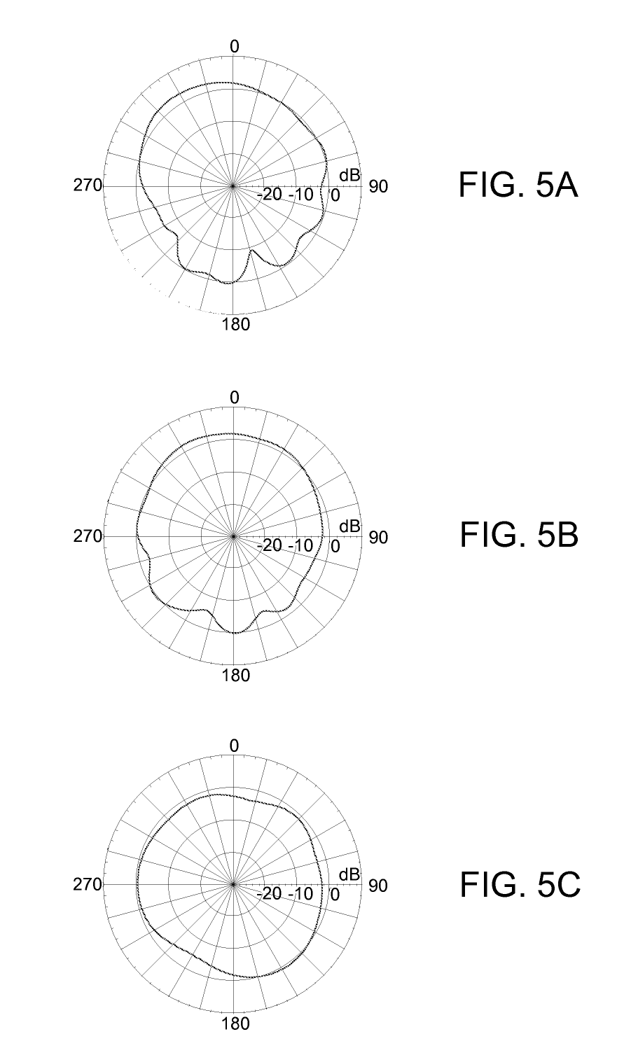

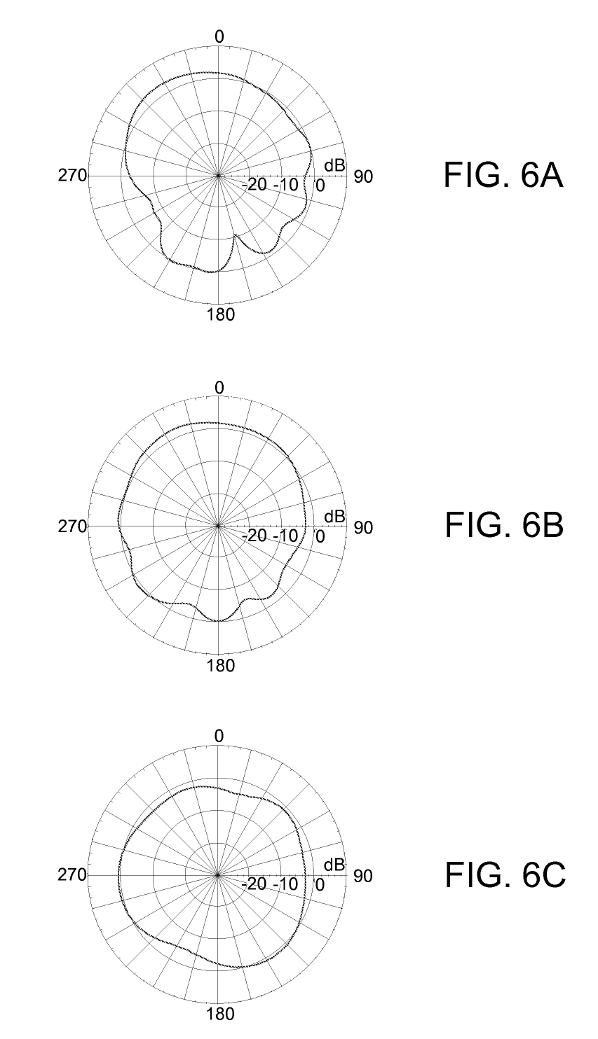

To further elaborate that the PIFA antenna 10 disposed in the housing of the electronic device can function normally, the following FIG. 4A, FIG. 4B, FIG. 4C, FIG. 5A, FIG. 5B. FIG. 5C, FIG. 6A, FIG. 6B and FIG. 6C respectively show the radiation field patterns of the PIFA antenna 10 operation under different bands.

Referring to at the same time FIG. 4A, 4B and 4C. FIG. 4A shows an X-Z plane radiation field pattern of the PIFA antenna 10 under 868 MHz. FIG. 4B shows a Y-Z plane radiation field pattern of the PIFA antenna 10 under 868 MHz. FIG. 4C shows an X-Y plane radiation field pattern of the PIFA antenna 10 under 868 MHz. When the operating frequency of the PIFA antenna 10 is equal to 868 MHz, the antenna gain is equal to 1.934 dBi and the efficiency is equal to 95.075%. The X-Z plane radiation field pattern of the PIFA antenna 10 under 868 MHz is illustrated in FIG. 4A. The Y-Z plane radiation field pattern of the PIFA antenna 10 under 868 MHz is illustrated in FIG. 4B. The X-Y plane radiation field pattern of the PIFA antenna 10 under 868 MHz is illustrated in FIG. 4C.

Referring to FIG. 5A, 5B and 5C at the same time. FIG. 5A shows an X-Z plane radiation field pattern of the PIFA antenna 10 under 888 MHz. FIG. 5B shows a Y-Z plane radiation field pattern of the PIFA antenna 10 under 888 MHz. FIG. 5C shows an X-Y plane radiation field pattern of the PIFA antenna 10 under 888 MHz. When the operating frequency of the PIFA antenna 10 is equal to 888 MHz, the antenna gain is equal to 2.674 dBi and the efficiency is equal to 87.745%. The X-Z plane radiation field pattern of the PIFA antenna 10 under 888 MHz is illustrated in FIG. 5A. The Y-Z plane radiation field pattern of the PIFA antenna 10 under 888 MHz is illustrated in FIG. 5B. The X-Y plane radiation field pattern of the PIFA antenna 10 under 888 MHz is illustrated in FIG. 5C.

Referring to FIG. 6A, 6B and 6C at the same time. FIG. 6A shows an X-Z plane radiation field pattern of the PIFA antenna 10 under 908 MHz. FIG. 6B shows a Y-Z plane radiation field pattern of the PIFA antenna 10 under 908 MHz. FIG. 6C shows an X-Y plane radiation field pattern of the PIFA antenna 10 under 908 MHz. When the operating frequency of the PIFA antenna 10 is equal to 908 MHz, the antenna gain is equal to 3.248 dBi and the efficiency is equal to 85.403%. The X-Z plane radiation field pattern of the PIFA antenna 10 under 908 MHz is illustrated in FIG. 6A. The Y-Z plane radiation field pattern of the PIFA antenna 10 under 908 MHz is illustrated in FIG. 6B. The X-Y plane radiation field pattern of the PIFA antenna 10 under 908 MHz is illustrated in FIG. 6C.

According to the above FIG. 4A, FIG. 4B, FIG. 4C, FIG. 5A, FIG. 5B, FIG. 5C, FIG. 6A, FIG. 6B and FIG. 6C, the efficiency of PIFA antenna 10 is always larger than 70%, and the gain is also larger than 1 dB no matter the PIFA antenna 10 under 868 MHz, 888 MHz or 908 MHz. Besides, according to the above FIG. 4A, FIG. 4B, FIG. 4C, FIG. 5A, FIG. 5B, FIG. 5C, FIG. 6A, FIG. 6B and FIG. 6C, the radiation field pattern of the PIFA antenna 10 is nearly round and there are no many indents on the edge. This implies that the PIFA antenna 10 has less dead zones in communication and can effectively transmit the wireless signal to all corners in the space. Thus, when the PIFA antenna 10 functions normally and has excellent quality in wireless communication even when the PIFA antenna 10 is disposed in the housing of electronic device.

According to the PIFA antenna disclosed in the above embodiment of the invention, the width of the radiation portion is larger than the width of the ground portion, such that the operating band of the PIFA antenna is capable of covering multiple bands. Thus, there is no need to have more than one antenna in response to different bands of the CE and FCC protocols.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A patched inverse F antenna (PIFA), comprising:
a ground portion;
a radiation portion, wherein the width of the radiation portion is larger than the width of the ground portion, such that the operating band of the PIFA antenna covers at least a first band and a second band at the same time;
a short-circuit portion disposed on the ground portion and connected to the radiation portion; and
a feed-in portion connected to the radiation portion.

2. The PIFA antenna according to claim 1, wherein the width of the short-circuit portion is equal to the width of the ground portion.

3. The PIFA antenna according to claim 1, wherein the ratio of the radiation portion vs. the width of the ground portion is larger than 1.15.

4. The PIFA antenna according to claim 1, wherein the ratio of the radiation portion vs. the width of the ground portion is smaller than 2.

5. The PIFA antenna according to claim 1, being conformed to Z-wave protocol.

6. The PIFA antenna according to claim 1, wherein the first operating band is 868 MHz, and the second operating band is 908 MHz.

7. The PIFA antenna according to claim 1, wherein the radiation portion is a rectangular metallic piece.

8. The PIFA antenna according to claim 1, wherein the ground portion is a rectangular metallic piece.

9. The PIFA antenna according to claim 1, wherein the short-circuit portion is a rectangular metallic piece.

10. The PIFA antenna according to claim 1, wherein one end of the short-circuit portion is connected to one end of the radiation portion, and the other end of the short-circuit portion is connected to one end of the ground portion.
